(19) United States
(12) Patent Application Publication
(10) Pub. No.: US 2010/0009203 A1
(43) Pub. Date: Jan. 14, 2010

(54) INSULATION LAYER AND METHOD FOR PRODUCING THEREOF

(76) Inventors: YOSHIKAZU NAGENO, KAWASAKI-SHI (JP); AKIRA INABA, KAWASAKI-SHI (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/169,881

(22) Filed: Jul. 9, 2008

(51) Int. Cl. B32B 17/06; B05D 3/02

(52) U.S. Cl. 428/428; 428/432; 427/375

(57) ABSTRACT

An insulation layer formed on a metal or ceramic substrate includes a glass component, wherein the glass component contains 0.1 to 10 wt % of B₂O₃ based on the total weight of the glass component. The insulation layer of the present invention exhibits few defects on the interface thereof with a substrate, even when fired at high temperature.

### BACKGROUND OF THE INVENTION

1. Field of the Invention

The invention relates to an insulation layer and the method for producing insulation layers. More specifically, the invention relates to an improvement of a glass component suitable for use in an insulation layer of electric device where the substrate of the device is made of metal or ceramic.

2. Technical Background

Various kinds of substrates, such as resin substrates, semiconductor substrates, ceramic substrates, metallic substrates or the like are used as substrates in electronic devices. In this context, there have been studies on the use of substrates having relatively high thermal conductivity, such as metallic substrates or ceramic substrates, as substrates for high heat-generating electronic components such as LEDs or the like. The luminescence of LEDs, which are members that generate a substantial amount of heat, tends to become impaired at high temperatures, and hence the development of heat-dissipating means is crucial.

For forming an electronic circuit on a substrate that uses a conductive substrate, an insulation layer is ordinarily formed on the substrate, by means of an insulation paste, followed by formation of the electronic circuit on the insulation layer. The electronic circuit is electrically connected to an electronic component, as the case may require.

The insulation paste may be, for instance, of firing type, having glass as a main constituent, or of thermocurable type, having a resin as a main constituent. In terms of packaging a high heat-generating electronic component, an insulation layer formed using a resin-based insulation paste may be susceptible to dielectric breakdown on account of thermal degradation of the resin. In an insulation layer formed using an insulation paste having glass as a main constituent, on the other hand, there occurs virtually no thermal degradation of glass. For packaging high heat-generating electronic components, therefore, the insulation layer is preferably formed using a glass-based paste.

However, it has become apparent that when the temperature of an electronic device is further raised, there appear defects on the interface between the insulation layer and the substrate, even when the insulation layer is formed using a glass-based paste. Specifically, the coefficient of thermal expansion (TCE) of the insulation layer and the TCE of the ceramic substrate or metallic substrate, which is preferably used for packaging of a high heat-generating electronic, are dissimilar. As a result, phenomena such as substrate warpage, cracking or the like may occur during sintering at high temperature, of 750° C. or above. In the manufacture of multilayer electronic circuit boards, in particular, an insulation paste is repeatedly applied and fired a number of times, whereby the temperature of the insulating underlayer is repeatedly raised. As a result, the adverse effect of the differences in coefficient of thermal expansion is made worse, for instance, on account of accumulating residual stresses, all of which impairs electronic device reliability and reduces manufacturing yield.

In the light of such problems, International patent No. WO 96/22881 proposed the feature of using glass having a coefficient of thermal expansion that matches that of a metallic substrate. Specifically, glass frit comprising zinc oxide, 28.68% by weight, magnesium oxide, 5.92% by weight, barium oxide, 6.21% by weight, aluminum oxide, 15.36% by weight and silicon oxide, 43.82% by weight; and glass frit comprising magnesium oxide, 29% by weight, aluminum oxide, 22% by weight, silicon oxide, 45% by weight and up to 5% by weight of oxides of phosphorus, boron and zirconium are suggested in WO96/22881. There is a need to improve the insulation layer formed on a substrate, such that defects occurring during firing are reduced, even at relatively high temperatures.

### SUMMARY OF THE INVENTION

The present invention is an insulation layer formed on a metal or ceramic substrate, comprising a glass component, wherein the glass component contains 0.1 to 10 wt % of B₂O₃ based on the total weight of the glass component.

Another aspect of the present invention is a method for producing an insulation layer, comprising the steps of: applying a glass paste onto a metal or ceramic substrate, the glass paste comprising a glass frit, an organic binder and a solvent, and the glass frit containing 0.1 to 10 wt % of B₂O₃, based on the total weight of the glass frit; drying the glass paste; and firing the dried glass paste.

The insulation layer of the present invention does exhibits few if any defects on the interface thereof with a substrate, even when fired at high temperature. The insulation layer of the present invention exhibits excellent characteristics of chemical durability and bonding strength.

### BRIEF DESCRIPTION OF THE DRAWINGS

FIG. 1A (before firing) and FIG. 1B (after firing) are schematic diagrams of a metallic substrate 1 and an insulation layer 2 that become warped after firing;

FIG. 2 is a graph illustrating the relationship between B₂O₃ content and warpage;

FIG. 3 is a graph illustrating the relationship between the amount of B₂O₃, and the glass transition temperature and softening temperature of the insulation layer;

FIG. 4 is a graph illustrating the relationship between amount of B₂O₃ and chemical durability, dipped into 0.1 N HNO₃ solution warmed at 50 degree C. and

FIG. 5A and FIG. 5B show a table describing the growth of crystal phases, based on X-ray diffraction analysis.

### DETAILED DESCRIPTION OF THE INVENTION

The insulation layer of the present invention is ordinarily formed on a metallic substrate or a ceramic substrate having high coefficient of thermal expansion (TCE)). The metallic substrate used is not particularly limited, and may comprise, for instance, stainless steel, carbon steel, copper, copper alloys, nickel, nickel alloys, titanium or the like. The ceramic substrate used is not particularly so limited, and may comprise, for instance, alumina, boron nitride, aluminum nitride, zirconia, magnesia or the like.

The TCE of the substrate used in the present invention is preferably of 7 to 13 ppm/K, more preferably of 8 to 11 ppm/K. Within the above ranges, TCE differences within the insulation layer can be easily reduced, and the occurrence of defects is dramatically suppressed.

Substrates having high thermal conductivity are particularly preferred for packaging high heat-generating electronic components such as LEDs or the like. Ordinarily, metallic substrates are preferably used from the viewpoint of heat dissipation. Although not particularly limited, thermal conductivity is preferably not smaller than 1 W/mK, more preferably not smaller than 10 W/mK. Within the above ranges, heat can be efficiently dissipated from the mounted electronic component.

The insulation layer of the present invention is, but is not limited to, manufactured by the following process.

First an insulation paste is prepared. The insulation paste is obtained by mixing the constituents of the paste. The constituent elements of ordinary insulation pastes are glass frit, a resin binder, and a solvent. The insulation paste may optionally comprise additives such as inorganic fillers, dispersants, stabilizers, plasticizers, stripping agents, defoamers, wetting agents or the like.

(A) Glass Frit

The insulation paste of the present invention contains an inorganic binder in the form of glass frit. The glass frit contains 0.1 to 10 wt % of B₂O₃ based on the total weight of the glass frit.

Ordinarily, when an insulation paste is coated onto a substrate and is fired, the longer the firing time, the greater the warpage becomes. The TCE of glass is normally lower than that of a metallic substrate made of, for instance, stainless steel, and hence a convex warpage forms as a result. Addition of an alkaline earth oxide having a large ionic radius, such as barium oxide or strontium oxide, is effective in suppressing the above phenomenon, as it allows bringing the TCE of the formed insulation layer closer to the TCE of the metallic substrate or the ceramic substrate. Substrate warpage, and occurrence of defects such as cracks or the like is suppressed as a result.

Also, substrate warpage, and occurrence of defects such as cracks or the like, are suppressed by inhibiting the formation of a low-TCE crystal phase in the glass, as a result the thermal treatment. Ordinarily, adding B₂O₃ tends to inhibit crystallization of glass. Also, the presence of B₂O₃ allows reducing the glass transition temperature and the softening temperature of glass frit, which in turn makes it possible to lower the firing temperature. The lower the firing temperature, the less likely it is that defects occur on account of TCE differences.

The mechanism whereby B₂O₃ elicits the above effect is uncertain, but one factor is the presence of celsian (BaAl₂Si₂O₈) having a low TCE. Celsian tends to form when B₂O₃ is not present. The TCE of celsian, of 2.3 ppm/K, is low, and thus the formation of celsian as a crystal phase in the glass frit is believed to exacerbate substrate warpage. On the other hand, substrate warpage is presumably reduced through inhibition of crystallization of celsian by adding B₂O₃.

In the present application, the content of B₂O₃ is preferably no greater than 10 wt % relative to the total weight of glass frit. An excessive B₂O₃ content tends to impair chemical durability. By contrast, an excessively small B₂O₃ content precludes eliciting the effect of B₂O₃. Accordingly, the content lower limit in the glass frit is 0.1 wt %. The content of B₂O₃ is preferably not lower than 0.5 wt %, more preferably not lower than 1.5 wt %, and in particular, not lower than 2.0 wt %. As regards the upper limit, the content of B₂O₃ is preferably no greater than 9.5 wt %, more preferably no greater than 9.0 wt %, and in particular, no greater than 8.0 wt %.

Components other than B₂O₃ that can be used in the glass frit are not particularly limited, and include, for instance, various glass types such as Si-based glass, Bi-based glass, Pb-based glass or the like. An amorphous glass is preferably used in terms of preventing cracks in the insulation layer. Cracking is less likely to occur when using an amorphous glass than when using a crystalline glass.

Examples of preferred glass compositions include, for instance, a glass frit comprising 20 to 60 wt % of SiO₂, 10 to 60 wt % of alkaline earth metal oxide, 5 to 30 wt % of ZnO, 0.5 to 7 wt % of ZrO₂, 0.1 to 10 wt % of B₂O₃, and 0 to 14 wt% of Al₂O₃ based on the total weight of the glass frit. The above glass frit may also comprise components other than those above-listed ones.

Silica (SiO₂) has the function of forming a network in the glass frit. The content of silica is preferably of 20 to 60 wt %, more preferably of 40 to 60 wt %, and yet more preferably off 45 to 55 wt %, based on the total weight of the glass frit. When silica is excessive, the softening point of glass rises. On the other hand, too little silica promotes glass crystallization and may impair the sealing performance of the formed insulation layer.

Zinc oxide (ZnO) lowers the softening point, increases the flowability of glass, and enhances the electric characteristics of the insulation layer. Added in excess, ZnO lowers the TCE of glass.

The TCE of the insulation layer can be further brought close to that of the metal substrate or of the ceramic substrate when ZnO is present together with an alkaline earth metal in the form of MgO, CaO, SrO or BaO. Preferred contents in this case are 0 to 5 wt % of MgO, 0 to 8 wt % of CaO, 5 to 20 wt % of SrO and 15 to 45 wt % of BaO, based on the total weight of the glass frit.

Zirconia (ZrO₂) increases the flowability of glass, and enhances the electric characteristics of the insulation layer. Adding zirconia allows lowering the dissipation factor and increasing dielectric properties, while reducing blistering. Zirconia has low compatibility with glass systems, and hence it is difficult to mix substantial amounts of zirconia into glass. With that in mind, the addition amount of zirconia is preferably 0.1 to 5 wt %, more preferably 1 to 4 wt %.

Adding alumina (Al₂O₃) allows enhancing chemical durability. However, alumina functions as a crystallization promoter. If alumina is added, therefore, the amount thereof is preferably 0.1 to 10 wt %, more preferably 0.5 to 5 wt %.

The glasses are prepared by conventional glass-making techniques, i.e., by mixing the desired components in the desired proportions and heating the mixture to form a melt. As is well known in the art, heating is conducted to a peak temperature and for a time such that the melt becomes entirely liquid and homogeneous.

In preparing the compositions of the invention, the components are premixed by shaking in a polyethylene jar with plastic balls and then melted in a platinum or ceramic container at about 1550° C. The melt is heated at the peak temperature for a period of at least one hour. Heating for less than one hour may result in inhomogeniety in the glass. A heating time of 1.5 to 2 hours is preferred.

The melt is then poured into cold water. The maximum temperature of the water during quenching is kept below 120° F. by increasing the volumetric ratio of water to melt. The crude frit after separation from water is freed of residual water by drying in air or by displacing the water with methanol. The crude frit in slurry form is then ball milled in alumina containers using alumina balls. Alumina picked up by the materials, if any, is not within observable limits as measured by x-ray diffractional analysis.

After discharging the milled frit slurry from the mill, excess solvent is removed by decantation and the frit powder is air dried at 130° C. The dried powder is then screened through a 325 standard mesh screen to remove any large particles.

The content of the glass frit in the insulation paste, but is not limited to, preferably 0.5 to 15.0 wt %, and more preferably 1.0 to 10.0 wt % based on the total weight of the insulation paste.

(B) Organic Binder

An organic binder is used to allow constituents such as glass frit to be dispersed in the paste. The organic binder is burned off in sintering process at elevated temperature.

Examples of the organic binders include poly(vinyl butyral), poly(vinyl acetate), poly(vinyl alcohol), cellulosic polymers such as methyl cellulose, ethyl cellulose, hydroxyethyl cellulose, methylhydroxyethyl cellulose, atactic polypropylene, polyethylene, silicon polymers such as poly(methyl siloxane), poly(methylphenyl siloxane), polystyrene, butadiene/styrene copolymer, polystyrene, poly(vinyl pyrrolidone), polyamides, high molecular weight polyethers, copolymers of ethylene oxide and propylene oxide, polyacrylamides, and various acrylic polymers such as sodium polyacrylate, poly (lower alkyl acrylates), poly (lower alkyl methacrylates) and various copolymers and multipolymers of lower alkyl acrylates and methacrylates. Copolymers of ethyl methacrylate and methyl acrylate and terpolymers of ethyl acrylate, methyl methacrylate and methacrylic acid.

The molecular weight of the organic binder is not particularly limited, but is preferably less than 50,000, more preferably less than 25,000, and even more preferably less than 15,000.

The content of the organic binder in the insulation paste is preferably 0.5 to 20 wt %, and more preferably 1 to 5 wt %, based on the total weight of the insulation paste.

(C) Solvent

The primary purpose for using an organic solvent is to allow the dispersion of solids contained in the composition to be readily applied to the substrate. As such, the organic solvent is preferred to first of all be one that allows the solids to be dispersed while maintaining suitable stability. Secondly, the rheological properties of the organic solvent is preferred to endow the dispersion with favorable application properties.

The organic solvent may be a single component or a mixture of organic solvents. The organic solvent that is selected is preferred to be one in which the polymer and other organic components can be completely dissolved. The organic solvent that is selected is preferred to be inert to the other ingredients in the composition. The organic solvent is preferred to have sufficiently high volatility, and is preferred to be able to evaporate off from the dispersion even when applied at a relatively low temperature in the atmosphere. The solvent is preferred not to be so volatile that the paste on the screen will rapidly dry at ordinary temperature during the printing process.

The boiling point of the organic solvent at ordinary pressure is preferred to be no more than 300° C, and more preferably no more than 250° C.

Specific examples of organic solvents include aliphatic alcohols and esters of those alcohols such as acetate esters or propionate esters; terpenes such as turpentine, terpineol, or mixtures thereof; ethylene glycol or esters of ethylene glycol such as ethylene glycol monobutyl ether or butyl cellosolve acetate; butyl carbitol or esters of carbitol such as butyl carbitol acetate and carbitol acetate; and Texanol (2,2,4-trimethyl-1,3-pentanediol monoisobutyrate).

The content of the solvent in the insulation paste, is preferably 15 to 50 wt %, and more preferably 20 to 40 wt % based on the total weight of the insulation paste.

(D) Inorganic filler

An inorganic filler is preferably added to the insulation paste with a view to adjusting the coefficient of thermal expansion, increasing thermal conductivity, and also for coloring, as a pigment. The inorganic filler that is added is not particularly limited, and may be, for instance, silica (SiO₂), alumina (Al₂O₃), titania (TiO₂), zinc oxide (ZnO), aluminum nitride (AlN) or boron nitride (BN), singly or in combinations of two or more.

When an inorganic filler is added to the insulation paste, the formed insulation layer comprises a component derived from the inorganic filler. However, the inorganic component from the glass frit and the inorganic component from the inorganic filler are not compatible and do not blend harmoniously at ordinary firing temperatures. Instead, the component from the inorganic filler becomes dispersed in the component from the glass frit. As a result, it is possible to tell apart whether the component derives from the glass frit or from the inorganic filler, even when the glass frit and the inorganic filler comprise both the same component.

The content of the inorganic filler in the insulation paste is preferably 0 to 50 wt %, and more preferably 5 to 40 wt % based on the total weight of the insulation paste.

The pastes are conveniently prepared on a three-roll mill. A preferred viscosity for these compositions is approximately 100 to 200 Pa s measured on a Brookfield HBT viscometer using a #5 spindle at 10 rpm.

The paste is applied to a substrate by means of screen printing or other printing method. In case screen printing is used, the paste is required to have appropriate viscosity so that they can be passed through the screen readily. In addition, the paste is preferred to thixotropic in order that they set up rapidly after being screened, thereby giving good resolution. While the rheological properties are of primary importance, the organic medium is preferably formulated also to give appropriate wettability of the solids and the substrate, good drying rate, dried film strength sufficient to withstand rough handling, and good firing properties. Satisfactory appearance of the fired composition is also important.

Prepared insulation paste is then applied onto the substrate. A typical method is screen printing, however other application methods may be used. The printed pattern is dried. Drying is preferably accomplished at 100 to 400° C. for 10 to 60 minutes.

The material that has been formed is sintered. The sintering temperature is not limited, but the present invention is especially beneficial when the paste is sintered at high temperature such as 700 to 950° C. Even if such a high temperature is adapted as the sintering condition, the defects caused by the difference of TCEs between the substrate and the insulation layer is effectively prevented. During the sintering process, the glass powder melts and becomes firmly attached to the substrate.

Cracks caused by TCE mismatch can be better prevented the closer the TCE of the formed insulation layer is to the TCE of the substrate. Specifically, the TCE of the formed insulation layer is preferably of 8.2 to 9.4 ppm/K.

The formed insulation layer comprises 0.1 to 10 wt % of B₂O₃, based on the total weight of the glass component. This affords, as a result, the above-described effects of substrate warpage suppression, crack prevention and so forth. In the present application, the term “glass component” denotes the component in the insulation layer that derives from glass frit. Although that component is comprised in the insulation paste as powder-like glass frit, firing results in component integration, whereupon the glass component in the insulation layer ceases to be powder-like. For differentiation purposes, therefore, the component formed from the glass frit is referred to as the “glass component”.

The composition of the glass component in the insulation layer corresponds to the composition of the glass frit, and thus the above explanation regarding the glass frit applies equally to the glass component. The explanation on the insulation paste applies also to other components such as the inorganic filler and so forth, and hence a redundant explanation thereof will be omitted herein.

After formation of the insulation layer, various materials such as electronic circuits, electrodes, electronic components or the like are arranged on the insulation layer in accordance with the use of the electronic member. Conventional technologies can be used for forming these materials, although, needless to say, newly developed technologies may be applied as well to that end.

### EXAMPLES

I. Evaluation of Thermal Properties of Insulation Layer, Chemical Durability and Resistance to Environmental Condition

I-1. Preparation of the Insulation Layer

The ingredients were weighed in proportions to produce the desired glass formula in table 1. The melts were fritted. The melts were caused to flow over a twin roller, to yield flake-like cullets. The cullets were dry-crushed by ball milling, and the obtained glass powders were graded using an air separator.

Ethyl cellulose (0.51 g) as the binder resin was dissolved in terpineol (3.41 g) as the solvent, followed by dilution with butyl carbitol acetate (BCA:3.92 g). To the resulting solution there was added Disperbyk-180, by BYK Chemie USA Inc. (0.16 g), as a dispersant, under stirring. This was followed by addition of the above glass powders (13.43 g), crystalline SiO₂ (3.06 g) as a TCE adjust powder and TiO₂ (0.5 g) as a pigment, with thorough mixing using a three-roll mill, to yield insulation pastes.

TABLE 1

| | | | | | | | | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 1 | Ex. 2 |
| Glass Frit | SiO₂ | 32.1 | 32.1 | 32.1 | 32.1 | 29.0 | 29.0 | 33.1 | 33.1 |
| composition | Al₂O₃ | 2.2 | 1.2 | 0.7 | 0.0 | 0.0 | 0.0 | 2.7 | 6.7 |
| (wt %) | ZrO₂ | 3.5 | 3.5 | 3.5 | 3.5 | 3.5 | 3.0 | 1.5 | 3.5 |
| | CaO | 5.5 | 5.5 | 5.5 | 5.5 | 5.5 | 5.5 | 4.5 | 4.5 |
| | ZnO | 15.6 | 15.6 | 15.6 | 15.6 | 15.6 | 12.0 | 15.6 | 15.6 |
| | BaO | 27.2 | 27.2 | 27.1 | 27.2 | 27.0 | 27.1 | 29.2 | 23.1 |
| | SrO | 13.4 | 13.4 | 13.4 | 13.4 | 13.4 | 13.4 | 13.4 | 13.4 |
| | B₂O₃ | 0.5 | 1.5 | 2.0 | 2.7 | 6.0 | 10.0 | 0.0 | 0.0 |
| | Total amount | 100 | 100 | 100 | 100 | 100 | 100 | 100 | 100 |
| Inorganic recipe of | Glass Frit | 79 | 79 | 79 | 79 | 79 | 79 | 79 | 79 |
| insulation paste | SiO₂ | 18 | 18 | 18 | 18 | 18 | 18 | 18 | 18 |
| (wt %) | TiO₂ | 3 | 3 | 3 | 3 | 3 | 3 | 3 | 3 |
| Thermal properties | TCE (ppm/K) | 9.2 | 8.9 | 9.3 | 9.3 | 9.1 | 8.8 | 9.2 | 8.5 |
| of insulation layer | Tg (° C.) | 710 | 683 | 672 | 678 | 642 | 640 | 712 | 731 |
| | Softening Point (° C.) | 733 | 721 | 719 | 702 | 670 | 665 | 735 | 752 |
| Chemical durability | 0.01N NaOH | 100 | 100 | 100 | 100 | 100 | 100 | 99.9 | 100 |
| (wt %) | 0.1N H₂SO₄ | 100 | 99.8 | 99.9 | 99.9 | 99.9 | 99.9 | 99.9 | 100 |
| | 0.1N HNO₃ | 89.9 | 94.8 | 98 | 96.4 | 95.6 | 57.2 | 85.3 | 99.6 |
| Resistance to | PCT (wt %) | 100 | 100 | 100 | 100 | 100 | 100 | 100 | 100 |
| environmental condition | | | | | | | | | |

I-2. Formation of the Insulation Layer

The insulation pastes were printed on a SUS substrate with thickness of 120 um. The thickness of the SUS substrate was 0.52 mm. Both the width and the length of the SUS substrate was 1 inch. The insulation pastes were printed onto one face of the SUS 430 2B substrates, excluding two 2-mm portions at both sides.

The SUS substrates with each dielectric paste were dried at 150° C. for 10 minutes, and then fired under 850° C. for 15 minutes respectively. TCE (ppm/K), Tg(° C.), softing Point(° C.), chemical durability and resistance to environmental condition of the insulation layer was measured. The result is shown in table 1.

I-3. Measurement Methods

I-3-1 Thermal Coefficient of Expansion

The coefficient of thermal expansion, as defined in JIS terminology 331, is a coefficient that denotes thermal expansion per 5° C. In the present application, the coefficient of thermal expansion was obtained through measurement under a load of 2 g, from room temperature up to the vicinity of the glass transition point, using a TMA-SS analyzer, by Seiko Instruments Inc. The coefficient of thermal expansion was calculated as an average from 50° C. to 350° C.

I-3-2 Softening Point and Glass Transition Point of Insulation Layer

The softening point and glass transition point of insulation layer were measured under a temperature rise rate of 10 K/min using a TG/DTA6200 analyzer, by Seiko Instruments Inc. A compact of the glass frit and the inorganic filler comprised in the insulation layer was prepared, and then the TCE of the compact was measured. The obtained value was taken as the TCE of the insulation layer formed using the paste.

I-3-3 Chemical Durability

Chemical durability was evaluated using specimens in which the insulation paste was printed to a thickness of 120 μm, after firing, on 2 inch×2 inch, 0.54 mm-thick alumina substrates. A 0.01N NaOH solution was used in an alkali resistance test. In an acid resistance test there were used a 0.1N H₂SO₄ solution and a 0.1N HNO₃ solution. The substrates having the insulation paste printed thereon were dipped for 1 hour in each solution, at 50° C., whereupon the reduction in weight from before to after the test was measured to calculate the weight percent of remaining insulation layer.

I-3-4 Resistance to Environmental Condition

In order to test resistance to environmental conditions, the samples manufactured in I-3-3 were kept for 2 days in an atmosphere at a temperature of 120° C., 95% humidity, and 2 atm pressure, using an apparatus (PC-304R8, by Hirayama Mfg. Corp.) for pressure cooker testing (PCT). The reduction in weight from before to after the test was measured to calculate the weight percent of remaining dielectric film.

II. Evaluation of Warpage

II-1. Formation of the Insulation Layer

Insulation layers were formed using the insulation pastes manufactured in I-1, in accordance with the following procedure. SUS 430 B2 substrate with the thickness of 0.4 mm was used as a ceramic substrate. The dielectric pastes were printed in a pattern which has a hole of mm in the center for measuring the volume of warpage. Three layers were printed and dried, then fired in the belt furnace at 850° C. The same process was repeated until 9 layers were built up. Then the warpage from the original position was measured.

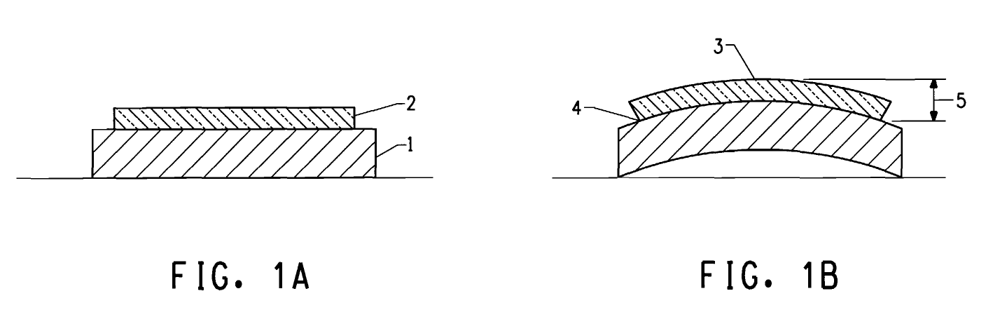

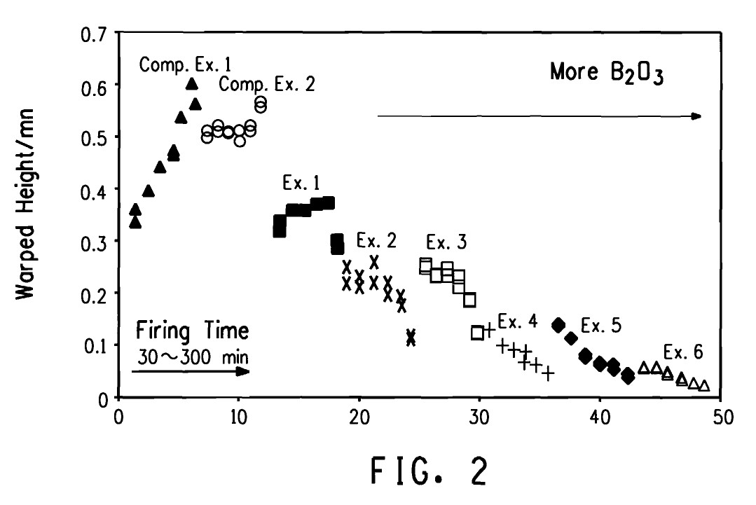

FIG. 1A (before firing) and FIG. 1B (after firing) illustrate a metallic substrate 1 and an insulation layer 2 that become warped after firing. Warpage height 5 was used in the test. Warpage height 5 was measured as the distance between the apex 3 of the insulation layer and the foot point 4 of the ridge of the insulation layer. FIG. 2 is a graph illustrating the relationship between B₂O₃ content and warpage. The Y-axis represents the amount of warpage in the various examples.

III. Analysis of Experimental Results

As Table 1 shows, the present invention allows bringing the TCE of the insulation layer closer to the TCE of the metallic substrate or of the ceramic substrate. Substrate warpage is curbed thereby, as illustrated in FIG. 2. This prevents as a result the occurrence of defects such as cracks and the like. As Table 1 shows, moreover, adding B₂O₃ affords durability against wire bonding and plating, without loss of chemical durability, and allows preserving quality over long periods of time.

The amount of warpage after firing, for Comparative example 1 and Examples 1 through 6, are plotted in FIG. 2. The amount of B₂O₃ is increasingly higher in the order: Comparative example 1, and Examples 1 through 6. The plots reflect the amount of warpage for each firing time, in Comparative example 1 and the examples. In Comparative example 1, for instance, the amount of warpage increases as the firing time lengthens from 30 minutes to 300 minutes. This tendency is reversed as the amount of B₂O₃ in the glass frit increases. That is, the amount of warpage decreases as the firing time lengthens from 30 minutes to 300 minutes. The overall trend is for a reduction in the amount of warpage as the amount of B₂O₃ increases.

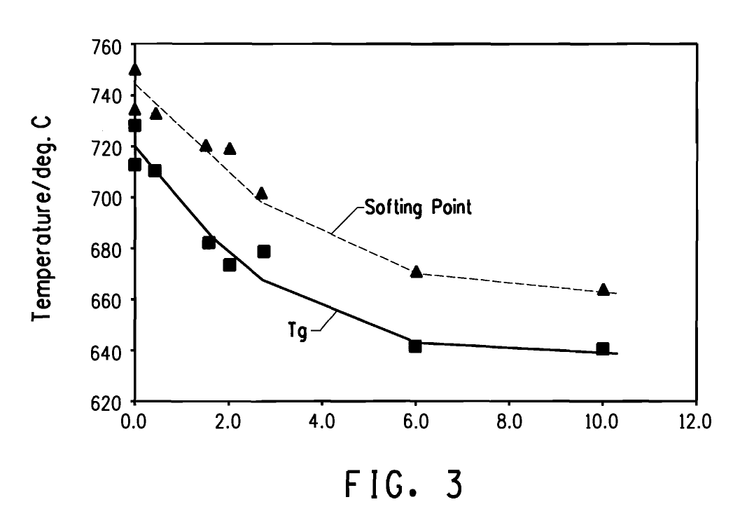

FIG. 3 is a graph illustrating the relationship between the amount of B₂O₃, and the glass transition temperature and softening temperature of the insulation layer. The glass transition temperature and the softening temperature tend to drop when the amount of B₂O₃ increases. The firing temperature can be lowered due to the lower Ts and Tg. This inhibits the occurrence of defects during firing on account of TCE differences.

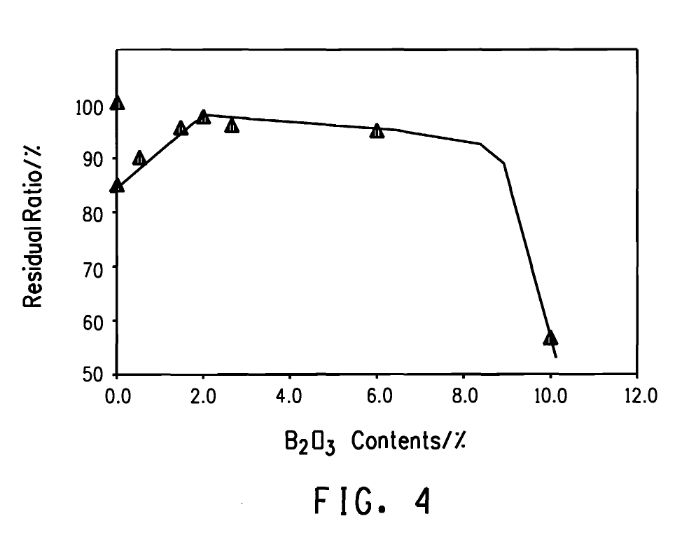

FIG. 4 is a graph illustrating the relationship between amount of B₂O₃ and chemical durability, dipped into 0.1 N HNO₃ solution warmed at 50 degree C. The glass transition temperature and the softening temperature tend to drop when the amount of B₂O₃ increases. Chemical durability tends to increase with B₂O₃ content, but, by contrast, drops when the amount of B₂O₃ is excessive.

IV. X-Ray Analysis

Compacts of the inorganic solid powders listed in Table 1 were prepared for studying the relationship between substrate warpage and crystallization of the glass component in the insulating phase, after firing at 850° C. Each specimen was treated at a firing temperature of 850° C. over a firing time of 30 minutes, 60 minutes, 150 minutes and 300 minutes. The treated specimens were crushed using an alumina mortar, and then the crystal phase in the glass phase was identified by powder diffraction using a RINT 1500 diffractometer, by Rigaku Co, (target Cu, tube voltage 40 kV, tube current 200 mA).

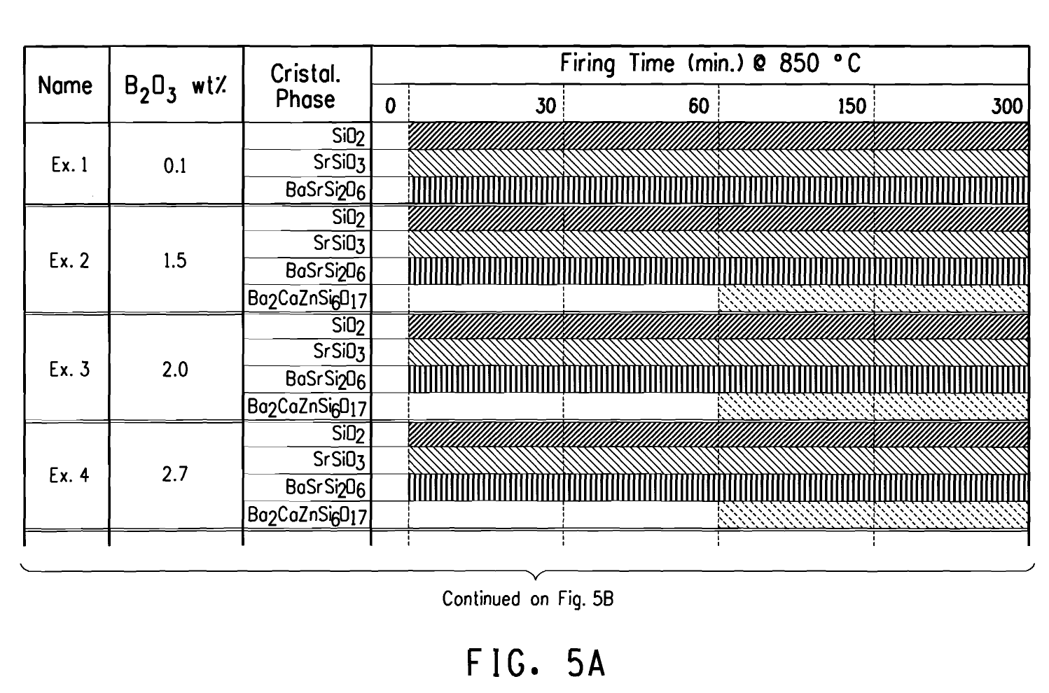

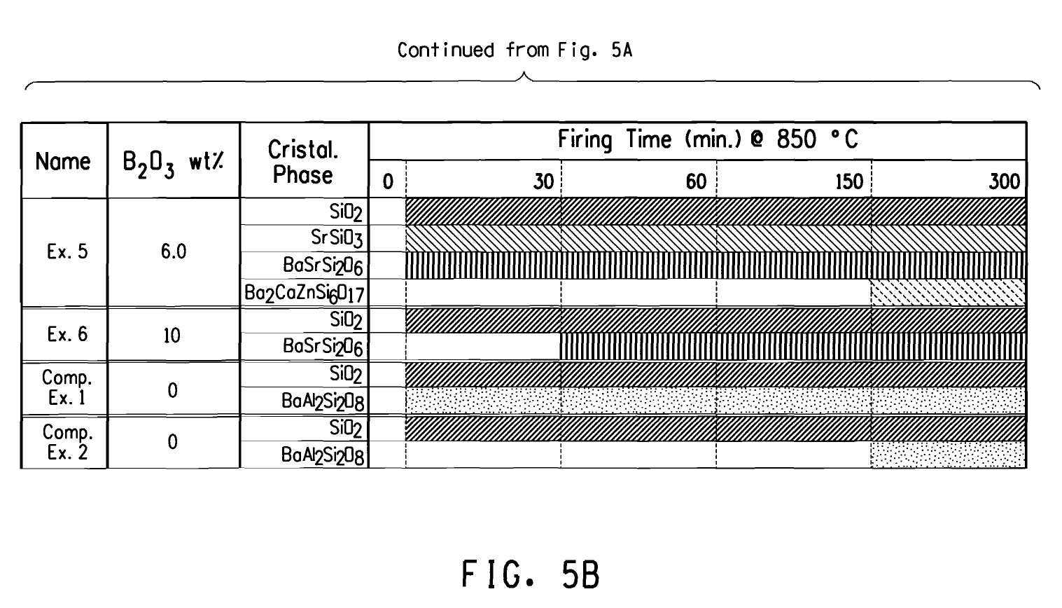

FIG. 5A and FIG. 5B is a table describing the growth of crystal phases, based on X-ray diffraction analysis. Formation of celsian (BaAl₂Si₂O₈) was observed in Comparative examples 1 and 2. In Comparative Example 1, celsian formation was observed within 30 minutes of firing, while in Comparative Example 2 celsian formation was observed within 300 minutes of firing. On the other hand, no celsian formation was observed in Examples 1 through 6. Herein there was observed formation of SrSiO₃ and BaSrSi₂O₆ and Ba₂CaZnSi₆O₁₇ after 150 minutes in Examples 2 through 5. This confirmed the influence of B₂O₃ on the formation of SrSiO₃, BaSrSi₂O₆ and Ba₂CaZnSi₆O₁₇.

We claim:

1. An insulation layer formed on a metal or ceramic substrate, comprising a glass component, wherein the glass component contains 0.1 to 10 wt % of B₂O₃ based on the total weight of the glass component.

2. An insulation layer according to claim 1, where the coefficient of thermal expansion (TCE) of the substrate is 7 to 13 ppm/K, and the TCE of the insulation layer is 8.2 to 9.4 ppm/K.

3. An insulation layer according to claim 1, where the glass component contains 20 to 60 wt % of SiO₂, 10 to 60 wt % of alkaline earth metal oxide, 5 to 30 wt % of ZnO, 0.5 to 7 wt % of ZrO₂, 0.1 to 10 wt % of B₂O₃, and 0 to 14 wt % of Al₂O₃, based on the total weight of the glass component.

4. An insulation layer according to claim 1, further comprising one or more inorganic filler selected from the group consisting of SiO₂, Al₂O₃, TiO₂, ZnO, AlN and BN.

5. A method for producing an insulation layer, comprising the steps of:
applying a glass paste onto a metal or ceramic substrate, the glass paste comprising a glass frit, an organic binder and a solvent, and the glass frit containing 0.1 to 10 wt % of B₂O₃ based on the total weight of the glass frit;
drying the glass paste; and
firing the dried glass paste.

6. A method for producing an insulation layer according to claim 5, where the coefficient of thermal coefficient of expansion (TCE) of the substrate is 7 to 13 ppm/K, and the TCE of the formed insulation layer is 8.2 to 9.4 ppm/K.

7. A method for producing an insulation layer according to claim 5, where the glass frit contains 20 to 60 wt % of SiO₂, 10 to 60 wt % of alkaline earth metal oxide, 5 to 30 wt % of ZnO, 0.5 to 7 wt % of ZrO₂, 0.1 to 10 wt % of B₂O₃, and 0 to 14 wt % of Al₂O₃, based on the total weight of the glass frit.

8. A method for producing an insulation layer according to claim 5, wherein the glass paste further comprises one or more inorganic filler selected from the group consisting of SiO₂, Al₂O₃, TiO₂, ZnO, AlN and BN.

9. A method for producing an insulation layer according to claim 5, wherein the paste is dried at the temperature range of 100 to 400° C., and the paste is fired at the temperature range of 700 to 950° C.
